(19) United States
(12) Patent Application Publication
(10) Pub. No.: US 2005/0168996 A1
(43) Pub. Date: Aug. 4, 2005

(54) Integral reflector and heat sink

(76) Inventors: John M. Koegler III, Corvallis, OR (US); Peter Guy Howard, Junction City, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/867,962

(22) Filed: Jun. 14, 2004

Related U.S. Application Data
(63) Continuation-in-part of application No. 10/769,355, filed on Jan. 30, 2004.

(51) Int. Cl. F21V 7/00

(52) U.S. Cl. 362/341

(57) ABSTRACT

An integral reflector and heat sink for use in a projector assembly includes a reflector portion comprising an integrated heat sink and a plurality of integral cooling fins connected to the integrated heat sink.

### RELATED APPLICATION

This application is a CIP of U.S. application Ser. No. 10/769,355 filed Jan. 30, 2004, which application is hereby incorporated by reference herein.

### BACKGROUND

Digital projectors, such as digital mirror devices (DMD) and liquid crystal display (LCD) projectors, project high quality images onto a viewing surface. Both DMD and LCD projectors utilize high intensity lamps and reflectors to generate the light needed for projection. Light generated by the lamp is concentrated as a ‘fireball’ that is located at a focal point of a reflector. Light produced by the fireball is directed into a projection assembly that produces images and utilizes the generated light to form the image. The image is then projected onto a viewing surface.

Efforts have been directed at making projectors more compact while making the image of higher and higher quality. As a result, the lamps utilized have become more compact and of higher intensity. An example of one type of such lamps is knows as a xenon lamp. Xenon lamps provide a relatively constant spectral output with significantly more output than other types of lamps without using substantial amounts of environmentally harmful materials, such as mercury. In addition, xenon lamps have the ability to hot strike and subsequently turn on at near full power.

Higher intensity lamps produce high, even extreme heat. If this heat is allowed to accumulate in the lamp, it may shorten the useful life of the lamp. For example, a Xenon lamp operating on 330 watts (W) of input power often produces about 69 W of visible light. The remaining power generates infrared radiation, black body radiation, and ultraviolet radiation or is consumed by electrical losses. As a result, the light generation assembly needs to dissipate about 250 W of power. Some designs attempt to dissipate the energy by reflecting the radiation away from the lamp and removing the heat with separate heat sinks.

Xenon lamps frequently make use of a ceramic reflector body. The ceramic reflector body is then coated with a reflective coating, such as a silver alloy. These reflective coatings do not adsorb a substantial amount of the radiation produced, but rather reflect it out of the lamp. As a result, sapphire lenses are frequently used with ceramic reflector bodies because they are able to withstand the heat load. Both the sapphire lenses and the reflective surface coatings are relatively expensive.

In addition, the ceramics used for reflector bodies typically have low thermal coefficients. As a result, ceramic reflector bodies do not absorb much heat. Instead, the heat is dissipated by separate heat sinks. These heat sinks are frequently coupled to the reflector by the anode, which provides a path of low thermal resistance. As a result, the amount of heat dissipated by the heat sink depends on the size and thermal resistance of the anode, because of the low heat transfer rate of the ceramic.

### SUMMARY

An integral reflector and heat sink for use in a projector assembly includes a reflector portion comprising an integrated heat sink and a plurality of integral cooling fins connected to the integrated heat sink.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1A illustrates a perspective view of an integral reflector and heat sink according to one exemplary embodiment.

FIG. 1B illustrates a rear view of an integral reflector and heat sink according to one exemplary embodiment.

FIG. 2 illustrates an exploded perspective view of a lamp assembly according to one exemplary embodiment.

FIG. 3 is a cross sectional view of a lamp assembly with a bottom-side sealing configuration according to one exemplary embodiment.

FIG. 4 is a cross sectional view of a lamp assembly with a top-side sealing configuration according to one exemplary embodiment.

FIG. 5 is a projector system according to one exemplary embodiment.

FIG. 6 is a method of forming an integral reflector and heat sink according to one exemplary embodiment.

Throughout the drawings, identical reference numbers designate similar, but not necessarily identical, elements.

### DETAILED DESCRIPTION

The present apparatuses and methods are related to an integral reflector and heat sink. The integral reflector and heat sink provide for enhanced cooling of a lamp assembly, thereby increasing the useful life of the lamp assembly. In addition, the integral reflector is formed of relatively inexpensive materials and thus may be formed rapidly with inexpensive techniques. Each of these factors allow for the formation of an inexpensive lamp assembly. As a result, the use of such inexpensive lamp assemblies and the increased useful life of the lamp assemblies may decrease the cost of making, owning and operating projection systems. Such lamp assemblies may include Xenon gas short-arc systems, such as those used in projection systems.

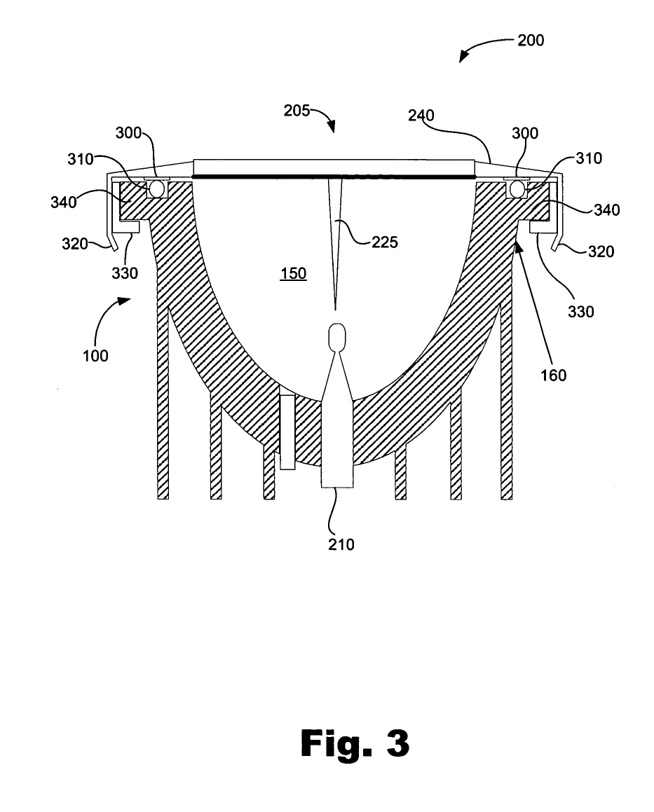

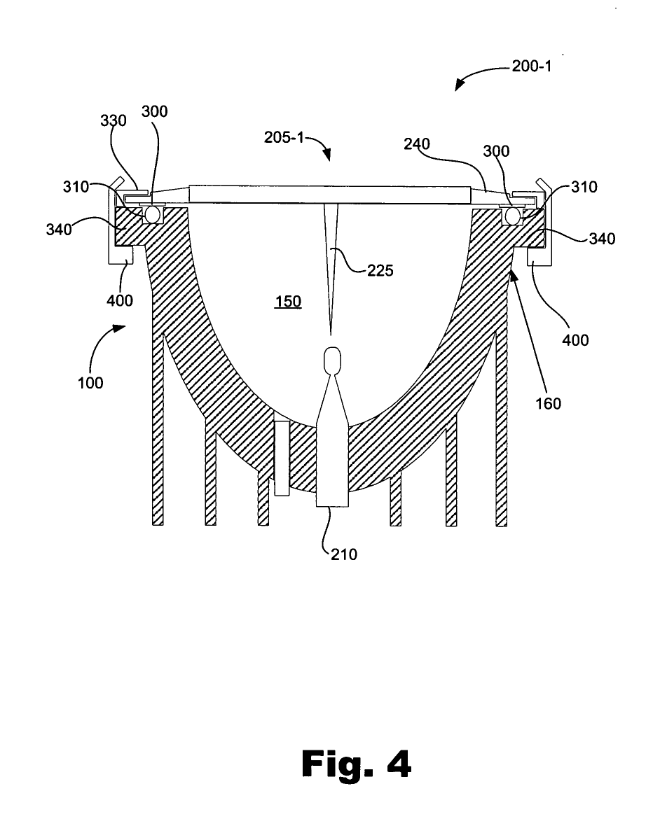

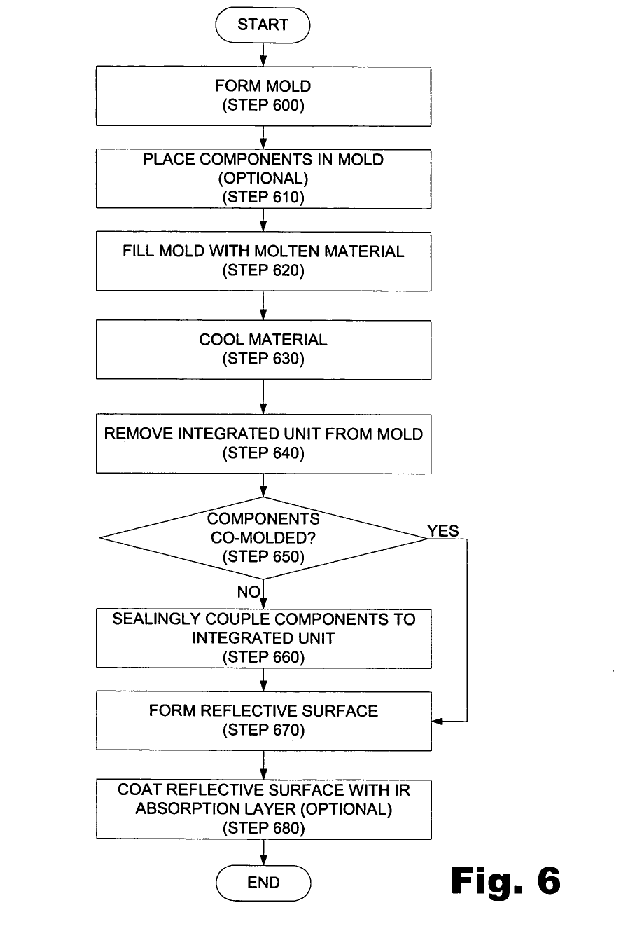

An integral reflector and heat sink will first be discussed, followed by an exemplary lamp assembly. Two exemplary sealing configurations will also be discussed in more detail with reference to FIGS. 3 and 4, followed by a description of an exemplary projection system that makes use of an integral reflector and heat sink. An exemplary method of forming an integral reflector and heat sink will then be discussed with reference to FIG. 6.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Integrated Reflector and Heat Sink

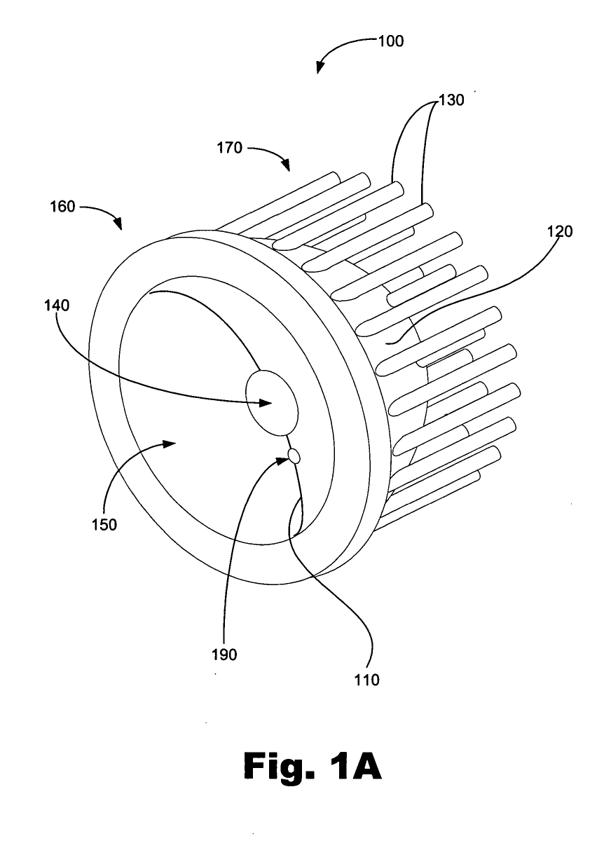

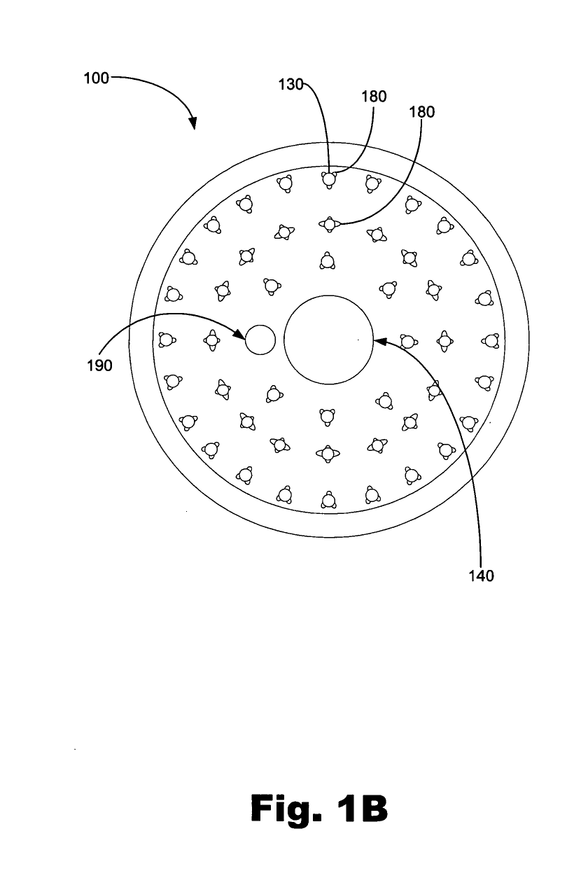

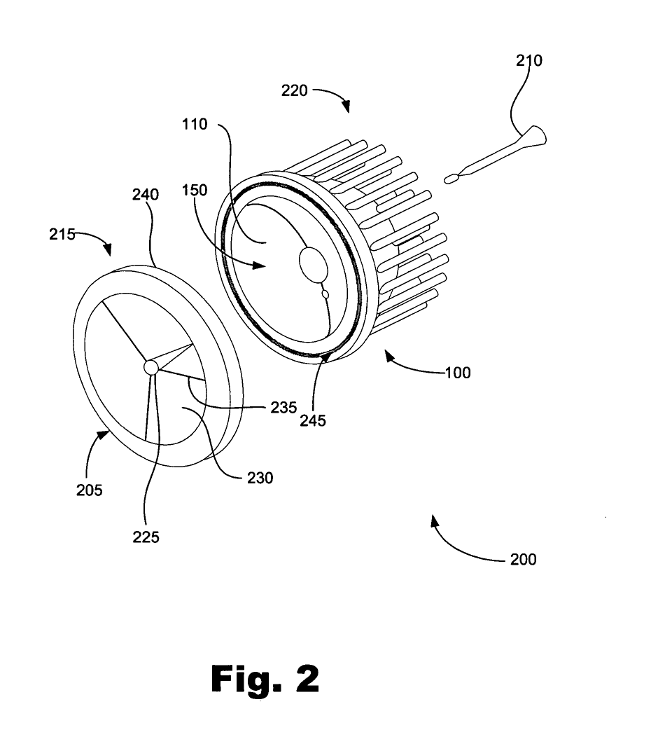

FIG. 1A illustrates an integral reflector and heat sink, referred to herein as the “integrated unit” (100). The integrated unit (100) is configured to be part of a lamp assembly, such as a Xenon lamp assembly, as will be discussed in more detail with reference to FIG. 2. The integrated unit (100) includes a reflective surface (110), a reflector body (120), a plurality of integral cooling fins (130) and a reflector opening (140). The integrated unit (100) reflects visible light out and dissipates energy through the reflector body (120) and the cooling fins (130).

The reflective surface (110) is formed in a cavity (150) defined in a distal end (160) of the reflector body (120). The cavity (150) may be hyperbolic or parabolic in profile. As a result, a substantial portion of light originating from a focal point of the cavity (150) reflects off the reflective surface (110) and out of the integrated unit (100). In a Xenon lamp assembly, light is generated when voltage arcs from an anode to a cathode in the presence of pressurized Xenon as will be discussed in more detail with reference to FIG. 2. The reflector opening (140) allows an anode to be coupled to the integrated unit (100).

Light in the visible spectrum is the desired output of a lamp used in projector systems. However, as previously discussed, lamps also generate significant radiant energy outside the visible spectrum. The reflective surface (110) may include a radiation absorption layer, such as an infrared and/or ultraviolet radiation absorption material to convert radiant energy to thermal heat. As radiant energy is converted to thermal heat by the infrared and/or ultraviolet radiation absorption layer, the radiant heat is absorbed by the reflector body (120) of the integrated unit (100).

The reflector body (120) is metallic. The use of a metallic reflector body allows thermal heat to be more readily absorbed by the reflector body (120), such that the reflector body (120) is an integrated heat sink. Heat absorbed by the reflector body (120) is then conveyed to the cooling fins (130).

FIG. 1B illustrates a rear view of the integrated unit (100) and showing the cooling fins (130) in more detail. The cooling fins (130) are shaped to increase the turbulence of an airflow passing over the cooling fins (130). These cooling fins (130) are annularly spaced about concentric rings around a proximal end (170) of the integrated unit (100) to increase the heat transfer rate.

The amount of heat transferred by an object depends, at least in part, on the exposed surface area of the object. The cooling fins (130) increase the heat the heat transfer rate by increasing the exposed surface area of the integrated unit (100). The spacing of the cooling fins (130) helps ensure that as air around one cooling fin is heated, that heated air will not substantially heat air around an adjacent cooling fin, thereby slowing heat transfer.

The amount of heat transferred by an object by convection, either natural or forced, depends at least in part on how the air flows over the object. Heat transfer may be maximized by increasing the speed of the airflow and/or by making the airflow turbulent. In the case of airflow generated in fan assemblies, the speed of the airflow used to cool lamps may be somewhat limited because of the noise, size, and other considerations. Accordingly, it may be desirable to make the air flow turbulent as it flows over the integrated unit (100).

The cooling fins (130) enhance heat removal from the reflector body (120). The cooling fins (130) are elongated members integrally formed with the reflector body (120) and thus may be made from the same material. The shape of the cooling fins (130) is such that an airflow that passes over the cooling fins (130) becomes turbulent.

For example, when an airflow is directed to the proximal end (170) of the integrated unit (100), the airflow becomes turbulent as it is disrupted by turbulence inducing features (180) on the cooling fins (130) and the reflector body (120). These turbulence inducing features (180) are formed on the cooling fins (130) to maximize the turbulence of the airflow as it passed over the cooling fins (130). As a result, the shape of the cooling fins (130) causes turbulent airflow, which increases the heat transfer rate of the integrated unit (100) by as much as a factor of two or more. Maximizing the amount of heat transferred from the reflector body reduces heat build-up in the cavity (150), which may increase the useful life of a lamp assembly.

The integrated unit (100) also includes a fill tube opening (190) that extends from the proximal end (170) of the integrated unit (100) to the cavity (150). The fill tube opening (190) provides a pathway for filling the cavity (150) with gases when the integrated unit (100) is assembled with the other components of a lamp assembly (200; FIG. 2). These other components and their interaction with the integrated unit will be discussed in more detail below.

Lamp Assembly with an Integrated Unit

FIG. 2 illustrates an exploded view of a lamp assembly (200) that includes an integrated unit (100), a cathode assembly (205), and an anode (210). When the lamp assembly (200) is assembled, the anode (210) is sealingly coupled to the integrated unit (100). The cathode assembly (205) is also sealingly coupled to the integrated unit (100).

In the exemplary embodiment shown in FIG. 2, the anode (210) is coupled to integrated unit (100) by placing the passing the anode (210) through the reflector opening (140). When the entire lamp assembly (200) is assembled, the end of the anode (210) and the end of the cathode (225) are spaced a precise distance from each other.

The distance by which the anode (210) and the cathode (225) are separated is referred to as the gap distance. By establishing the proper gap distance, light is generated when voltage is applied to the anode (210) while the cavity (150) is filled with a pressurized gas, such as Xenon.

The gas is introduced to the cavity (150) through the fill tube (180). More specifically, the cathode assembly (205) is sealingly coupled to the integrated unit (100) such that the cavity (150) is substantially sealed from the outside environment with respect to the distal end (215) of the integrated unit (100).

The fill tube (180) provides access to the cavity (150) through the proximal end (220) of the integrated unit (100). After the cavity (150) is filled with gas through the fill tube (180), the fill tube (180) is sealed to prevent the gas in the cavity (150) from escaping. The formation of the integrated unit (100) will be discussed in more detail with reference to FIG. 6.

The cathode assembly (205) provides an electrical path between the anode (210) and a cathode (225) and provides support for the cathode (225). The cathode assembly (205) includes the cathode (225), a lens (230), cathode support structure (235) and a face cap (240). The cathode (225) is coupled to the cathode support structure (235) to support the cathode (225). Accordingly, the face cap (240) and the cathode support structure (235) provide physical support for the cathode (225).

The cathode support structure (235) and the face cap (240) also provide thermal and electrical pathways for the cathode (225). With respect the thermal pathway, both the face cap (240) and the cathode support structure (235) are made of a material with low thermal resistance, such as metal. As a result, heat that accumulates on the cathode (225) is conveyed to the face cap (240) through the support structure (235). Consequently, the face cap (240) acts as a heat sink for removing heat from the cathode (225).

The integrated unit (100) reduces the amount of heat that accumulates in the cavity (150). In addition, less radiation is reflected out of the integrated unit (100) and through the lens (230) because radiation may be absorbed by an infrared and/or ultraviolet radiation absorption layer applied to the reflective surface (110). Accordingly, the amount of heat dissipated by the face cap (240) and the amount of radiant energy conveyed to the lens (230) is also reduced.

As previously discussed, relatively expensive lenses, such as sapphire lenses, are typically used to prevent devitrification or frosting of the lens (230) due to the heat load associated with radiation and the heat load in the cavity (150). The increased heat dissipation allowed by the integrated unit (100) may allow for the use quartz glass for the lens (150). Quartz glass is less expensive than sapphire. Accordingly, the use of a quart glass lens may decrease the cost of the lamp assembly (200) while providing adequate light transmission for light generated by the lamp assembly (200).

In addition to providing thermal pathways and to providing for the use of less expensive materials, the cathode support structure (235) and the face cap (240) provide an electrical pathway for the cathode (225). The cathode support structure (235) and the face cap (240) are made of electrically conductive material, such as metal, so that cathode (225) is at substantially the same voltage level as the face cap (240). The face cap (240) is electrically charged. Consequently, when voltage is applied to the cathode (225) in the presence of a pressurized gas, the voltage arcs across the gap distance to the anode (210) because the anode (210) is at a lower voltage level or ground.

The anode (210) is in physical contact with the integrated unit (100). Thus the anode (210) is at the same voltage level as the integrated unit (100). Accordingly, the integrated unit (100) and the anode (210) need to be physically separated from the cathode (225) and the cathode assembly (205). The integrated unit shown (100) has a channel (245) in the distal end (160). The channel (245) allows the cathode assembly (205) to be sealingly coupled to the integrated unit (100) without coming in direct physical contact therewith. Two exemplary sealing arrangements and the electrical insulation between the integrated unit (100) and the cathode assembly will now be discussed with reference to FIGS. 3-4.

FIG. 3 is a cross sectional view of the lamp assembly (200) showing the sealing relationship of the cathode assembly (205) with respect to the integrated unit (100). As previously discussed, in the illustrated embodiment the cathode assembly (205) and the integrated unit (100) are physically separated one from another such that when voltage is applied to the lamp assembly (200), the voltage arcs from the cathode (225) to the anode (210) in the presence of a gas. This gas must be maintained in the cavity (150) for the lamp assembly to operate properly. Accordingly, the cathode assembly (205) is sealingly coupled to the integrated unit (100) while maintaining physical separation between the metallic face cap (240) and the integrated unit (100).

The exemplary cathode assembly (205) shown makes use of a bottom-side sealing configuration to maintain this sealing relationship. In particular, the cathode assembly (205) has a non-conductive seal, such as a ceramic gasket seal (300), which is placed in contact with the distal end (160) of the integrated unit (100). This portion of the distal end (160) of the integrated unit (100) includes a ring seal (310) that is placed at least partially within the channel (245). The ceramic gasket seal (300) interacts with the ring seal (310) to seal the cathode assembly (205) to the integrated unit (100) without placing the metallic face cap (240) in contact with the integrated unit (100).

A force applied between the ceramic gasket seal (300) and the ring seal (310) helps ensure the seal will be most effective. This force is applied by the interaction of the face cap (240) and the integrated unit (100). The face cap (240) includes sealing flanges (320) to provide the sealing force. An insulator (330) is placed between the sealing flanges (320) and the integrated unit (100) to prevent the face cap (240) from coming into direct physical contact with the integrated unit (100).

To couple the cathode assembly (205) to the integrated unit, force is applied to the integrated unit (100) and the cathode assembly (205) in opposing directions. As the force is applied, the sealing flanges (320) are deformed slightly as they pass over the lip (340) of the integrated unit (100) and the insulator (330). At the same time, the ceramic gasket seal (300) comes into contact with the ring seal (310), thereby compressing the ring seal (310), which is made of a semi-deformable high temperature material.

As the sealing flanges (320) pass the end of the insulator (330), the sealing flanges (320) return to their un-deformed shape, such that a portion of the sealing flanges (320) are below the insulator (330). This relationship between the sealing flanges (320) and the insulator (330) maintains a compressive force on the ceramic gasket seal (300) and the ring seal (310) to ensure that the ceramic gasket seal (300) and the ring seal (310) remain in sealing contact.

Accordingly, the ceramic gasket seal (300) and the ring seal (310) are maintained in sealing contact by pushing the sealing flanges (320) of the face cap (240) past the insulator (330). This configuration allows the cathode assembly (204) to be sealingly coupled to the integrated unit (100) without placing their metal components in physical contact with each other.

FIG. 4 is a cross sectional view of a lamp assembly (200-1) that makes use of a top-side sealing configuration. The bottom of the cathode assembly (205-1) is separated from the integrated unit (100) by the ceramic gasket seal (300) and the ring seal (310) as previously discussed.

The insulator (330-1) is placed on top of the face cap (240-1), which is shaped to the have the insulator (330-1) mated thereto. The lamp assembly (200-1) also includes a metal crimp seal (400). The metal crimp seal (400) is in contact with the bottom of the lip (340) and the top of the insulator (330-1). A compressive force is applied to the ceramic gasket seal (300) and the ring seal (310) by crimping the metal crimp seal (400).

Accordingly, the ceramic gasket seal (300) and the ring seal (310) are maintained in sealing contact by crimping the metal crimp seal (400). This configuration allows the cathode assembly (204) to be sealingly coupled to the integrated unit (100) without placing their metal components in physical contact with each other.

Projector System Having an Integrated Unit

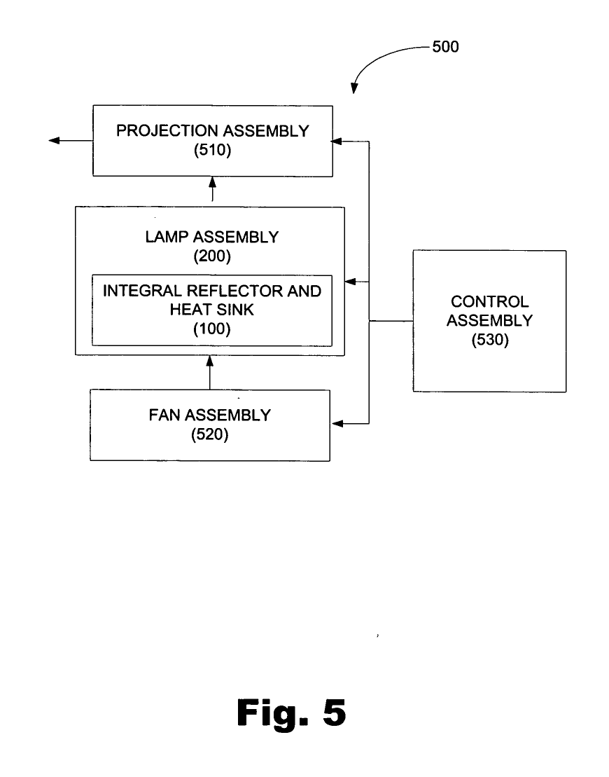

FIG. 5 is a schematic representation of a projector system (500) that generally includes a lamp assembly (200), a projection assembly (510), and a fan assembly (520) each coupled to a control assembly (530). The control assembly (530) controls the activation of the lamp assembly (200). When the control assembly (530) activates the lamp assembly (200), the control assembly (530) also activates the fan assembly (520). Consequently, if the lamp assembly (200) is on, the fan assembly (520) is directing air thereto.

The control assembly also controls the projection assembly (510), which may be a spatial light modulator (SLM) such as a liquid crystal display (LCD), a liquid crystal on silicon (LCOS), or a digital mirror device (DMD) type projection assembly. Light from the light generation assembly (200) is directed to the projection assembly (510) where it is manipulated to form an image that is then projected onto a viewing surface.

Heat generated by the lamp assembly (200) is drawn into the integrated unit (100), which is then cooled by air from the fan assembly (520). As previously discussed, the radiation absorbing coating on the reflector surface (110; FIG. 1) increases the amount of heat absorbed by the integrated unit (100; FIG. 1). The cooling fins (130; FIG. 1) draw heat from the integrated unit (100; FIG. 1). The fan assembly (520) directs an air flow over the cooling fins (130; FIG. 1 to cool them by forced convection. As previously discussed, the cooling fins (130; FIG. 1) are configured to cause the air flow to become turbulent. As a result, heat is dissipated more quickly, thereby maximizing the amount of heat transferred from the lamp assembly (200; FIG. 2). The formation of an integrated unit (100) will now be discussed in more detail below with reference to FIG. 6.

Formation of an Integrated Unit

FIG. 6 is a flowchart showing a method of forming an integrated unit. The method begins by forming a mold (step 600). One suitable mold is a die-casting mold that is shaped to form an integrated unit, including the cooling fins. The mold also may include features for forming a reflector opening and an opening to accommodate a fill tube. If the mold does not include features for forming these openings, the mold may also include features therein to allow these components to be co-molded into the integrated unit.

For example, the fill tube (180; FIG. 1) and/or the anode (210; FIG. 2) may be placed into the mold (step 610), after the mold has been formed. Co-molding these components with the integrated unit may help ensure that a sealing relationship is established and maintained between the co-molded components and the integrated unit.

The mold is then filled with molten material (step 620) by forcing the molten material into the mold under pressure, as is the case in die casting operations. The pressure helps to ensure molten material fills all of the cavities in the mold, including those used to form the cooling fins. This molten material may be a metal, such as zinc, aluminum, magnesium, copper, and/or alloys of these metals. The use of the metal to form the integrated unit may allow the integrated unit to dissipate heat more rapidly, as been previously discussed.

After the mold is filled with molten material (step 620), the material is allowed to cool and solidify (step 630) after which the integrated unit is removed from the mold (step 640). It is then determined whether the components previously discussed have been co-molded with the integrated unit (determination 650). If the components previously discussed, such as the fill tube and/or the anode have not been co-molded with the integrated unit (NO, determination 650), these components are then sealingly coupled to the integrated unit (step 660).

These components may be sealingly coupled to the integrated unit by pushing the component into a corresponding opening formed in the integrated unit. For example, the fill tube may be pushed through the opening defined in the integrated unit for accommodating the fill tube. Once the fill tube is in place, the perimeter of the fill tube may then be brazed to the integrated unit to help ensure a sealing relationship between the integrated unit and the fill tube. The anode may be sealingly coupled to the reflector opening in a similar manner.

Once the fill tube and anode are in place, either by sealingly coupling the fill tube and anode as just discussed or by co-molding the fill tube and anode with the integrated unit as discussed with reference to steps 610-620, a reflective surface is established in the integrated unit (step 670). As previously discussed, the integrated unit is formed of a metallic material. The use of metallic material may allow the reflector surface to be machined to form the reflective surface. Machining may be done with conventional tools, such as milling machines, such that the formation of the reflective surface may be done rapidly and inexpensively.

The reflective surface may then optionally be coated with an infrared and/or ultraviolet radiation absorbing layer (step 680). The radiation absorbing layer converts infrared and ultraviolet radiation into thermal energy, which is then absorbed by the integrated unit and dissipated by the cooling fins as previously discussed.

Accordingly, the method just discussed allows for the rapid and inexpensive formation of an integrated unit that functions as a reflector and a heat sink. An integrated unit may then be used in a lamp assembly, such as those illustrated in FIGS. 2-4.

In conclusion the present apparatuses, assemblies, and methods provide for enhanced cooling of a lamp assembly, thereby increasing the useful life of the lamp assembly. In addition, the integral reflector is formed of relatively inexpensive materials and may be so formed rapidly with inexpensive techniques, each of which may allow for the formation of an inexpensive lamp assembly. Such lamp assemblies may include Xenon gas short arc systems, such as those used in projection systems. As a result, the use of such inexpensive lamp assemblies and the increased useful life of the lamp assemblies may decrease the cost of owning and operating projection systems.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

1. An integral reflector and heat sink for use in a projector assembly, comprising:
a reflector portion comprising an integrated heat sink; and
a plurality of integral cooling fins connected to said integrated heat sink.

2. The integral reflector and heat sink of claim 1, wherein said cooling fins further include turbulence inducing features formed thereon.

3. The integral reflector and heat sink of claim 1, wherein said cooling fins are spaced about concentric rings on a proximal end of said integrated heat sink and are configured to cause an airflow directed thereto to become turbulent.

4. The integral reflector and heat sink of claim 1, wherein said reflector portion comprises a metallic material.

5. The integral reflector and heat sink of claim 4, wherein said metallic material comprises zinc.

6. The integral reflector and heat sink of claim 4, wherein said metallic material comprises aluminum.

7. The integral reflector and heat sink of claim 4, wherein said metallic material comprises magnesium.

8. The integral reflector and heat sink of claim 4, wherein said metallic material comprises brass.

9. The integral reflector and heat sink of claim 4, wherein said metallic material comprises copper.

10. The integral reflector and heat sink of claim 1, wherein said reflector portion includes a cavity in a distal end thereof and said a reflective surface is established in said cavity and further comprising a radiation absorption coating on said reflective surface.

11. The integral reflector and heat sink of claim 10, wherein said radiation absorption coating includes infrared radiation absorption material.

12. The integral reflector and heat sink of claim 10, wherein said radiation absorption coating includes ultraviolet radiation absorption material.

13. The integral reflector and heat sink of claim 1, and further comprising a reflector opening defined in said reflector portion.

14. The integral reflector and heat sink of claim 1, and further comprising an anode sealingly coupled to said reflector portion.

15. The integral reflector and heat sink of claim 1, and further comprising a fill tube opening defined in said reflector portion.

16. The integral reflector and heat sink of claim 1, and further comprising a fill tube sealingly coupled to said fill tube opening.

17. A lamp assembly for use in a projector assembly, comprising:
an integral reflector and heat sink for use in a projector assembly including a reflector portion having an integrated heat sink, and a plurality of integral cooling fins connected to said integrated heat sink,
a cathode assembly having a face cap, a cathode support structure, and a cathode and being sealingly coupled to said integral reflector and heat sink; and
an anode coupled to said integral reflector and heat sink.

18. The lamp assembly of claim 17, wherein said integral reflector and heat sink further comprises a lip formed in a distal end thereof and a channel defined in said lip.

19. The lamp assembly of claim 18, and further comprising a first non-conductive seal between said face cap and said integral reflector and heat sink and a second seal disposed in said channel between said integral reflector and heat sink and said first seal.

20. The lamp assembly of claim 19, wherein said first non-conductive seal comprises a ceramic gasket seal and said second seal comprises a ring seal.

21. The lamp assembly of claim 19, and further comprising an insulator disposed between said face cap and said integral reflector and heat sink.

22. The lamp assembly of claim 21, wherein said face cap further includes sealing flanges disposed about a perimeter of said face cap.

23. The lamp assembly of claim 22, wherein said sealing flanges are configured to engage said insulator and to maintain said first non-conductive seal in contact with said second seal.

24. The lamp assembly of claim 21, and further comprising a crimp seal coupling said face cap to said integral reflector and heat sink and wherein said insulator prevents direct physical contact between said face cap and said integral reflector and heat sink.

25. The lamp assembly of claim 17, wherein said lens is a quartz glass lens.

26. The lamp assembly of claim 17, and further comprising a cavity defined in said integral reflector and heat sink and being substantially sealed from an atmosphere and having a noble gas contained therein.

27. The lamp assembly of claim 26, wherein said noble gas is Xenon.

28. A projector assembly, comprising:
a lamp assembly for use in a projector assembly including an integral reflector and heat sink for use in a projector assembly including a reflector portion having an integrated heat sink, and a plurality of integral cooling fins with turbulence inducing features defined thereon and connected to said integrated heat sink, a cathode assembly having a face cap, a cathode support structure, and a cathode and being sealingly coupled to said integral reflector and heat sink and an anode coupled to said integral reflector and heat sink; and
a projection assembly optically coupled to said light generation assembly.

29. The assembly of claim 28, wherein said projector assembly comprises an liquid crystal display.

30. The assembly of claim 28, wherein said projector assembly comprises a liquid crystal on silicon display.

31. The assembly of claim 28, wherein said projector assembly comprises a digital mirror device.

32. The assembly of claim 28, and further comprising a fan assembly for flowing air over said integral reflector and heat sink.

33. A method of forming an integral reflector and heat sink, comprising:
pouring molten material into a mold, said mold having features for forming reflector portion and a plurality of cooling fins;
cooling said molten material to a solidified material; and
removing said solidified material from said mold.

34. The method of claim 33, and further comprising placing at least one component into said mold before pouring said molten material into said mold.

35. The method of claim 34, wherein said component is a fill tube.

36. The method of claim 34, wherein said component is an anode.

37. The method of claim 33, and further comprising establishing a reflective surface on said reflector portion.

38. The method of claim 37, wherein establishing said reflective surface comprises machining said reflector portion.

39. The method of claim 37, and further comprising applying a radiation absorption layer to said reflective surface.

40. The method of claim 39, wherein said radiation absorption layer includes an infrared radiation absorption material.

41. The method of claim 39, wherein said radiation absorption layer includes an ultraviolet radiation absorption material.

42. The method of claim 39, and further comprising sealingly coupling an anode to said reflector portion.

43. The method of claim 39, and further comprising sealingly coupling a fill tube to said reflector portion.
